(19) United States
(12) Patent Application Publication
(10) Pub. No.: US 2024/0158275 A1
(43) Pub. Date: May 16, 2024

(54) PROCESS AND SYSTEM FOR MINERALIZING AND HYDROGENATING WATER WITH THE USE OF OSMOTIC PRESSURE

(71) Applicant: CORE PACIFIC INC., Houston, TX (US)

(72) Inventor: Patrick GWEN, Houston, TX (US)

(21) Appl. No.: 18/515,930

(22) Filed: Nov. 21, 2023

Related U.S. Application Data
(63) Continuation-in-part of application No. 18/175,998, filed on Feb. 28, 2023.
Application No. 18/175,998 is a continuation of application No. 17/815,479, filed on Jul. 27, 2022, now Pat. No. 11,597,669.

(51) Int. Cl. C02F 9/00

(52) U.S. Cl. CPC C02F 9/00; C02F 1/003

(57) ABSTRACT

A process for ionizing water includes forming an ionization chamber having a cathode compartment and an anode compartment with a proton exchange membrane separating the cathode compartment from the anode compartment, introducing a filtered water into the cathode compartment, introducing a brine into the anode compartment, applying an electrical charge to the anode compartment and to the cathode compartment such that ions from the brine flow through the proton exchange membrane to the filtered water of the cathode compartment, and removing the ionized filtered water on the cathode compartment. In particular, the anode compartment and the cathode compartment have an osmotic pressure differential therebetween such that a portion of the filtered water from the cathode compartment flows through the proton exchange membrane to the anode compartment.

### CROSS-REFERENCE TO RELATED APPLICATIONS

The present application is a continuation-in-part of U.S. patent application Ser. No. 18/175,998, filed on Feb. 28, 2023. U.S. patent application Ser. No. 18/175,998 is a continuation of U.S. patent application Ser. No. 17/815,479, filed on Jul. 27, 2022, now issued as U.S. Pat. No. 11,597,669, on Mar. 7, 2023.

### FIELD OF THE INVENTION

The present invention relates to The present invention relates to the hydrogenation of water. More particularly, the present invention relates to the use of reverse osmosis filters for the filtering of tapwater. The present invention also relates to the hydrogenation of the filtered water by using the brine from the reverse osmosis filter.

### DESCRIPTION OF RELATED ART

Hydrogen water is ordinary drinking water enriched with gaseous molecular hydrogen. Hydrogen water is tasteless and odorless. Hydrogen molecules in such water are, in no way, associated with water molecules. In other words, it contains hydrogen in its pure H₂ form. Therefore, the water formula does not change. Hydrogen water has pronounced therapeutic and wellness properties confirmed by numerous scientific studies on humans and animals. Today, more than 1500 studies worldwide, including the USA, Japan Korea, China, Serbia, Mexico, Germany and Slovakia, have been published on molecular hydrogen therapy and the study of hydrogen water effects on the human body.

In simple terms, aeration is typically saturated with CO₂ gas. In the production of hydrogen water, it is saturated with H₂ (hydrogen gas). Moreover, chemically, hydrogen is absolutely inert, i.e. it does not react or enter at high temperature or pressure. The hydrogen molecule has a high chemical potential, i.e. an effect on the biological and biochemical processes in the human body.

Today, according to research of the Molecular Hydrogen Institute, the most and influential international organization that deals with the therapeutic properties of hydrogen, more than 30% of the population of Japan and more than 20% of the South Korean population regularly use hydrogen water produced by a water machine.

The characteristics of hydrogen water include ORP (redox potential), pH, and the concentration of molecular hydrogen as measured in PPB/PPM. The negative oxidation-reduction potential (ORP) of hydrogen water can vary from 150 to 600 mV depending on how the process of saturation proceeds, the quality of water, its type, saltiness, etc. The pH value of hydrogen water, obtained using electrolysis technology and direct saturation (i.e. saturation with H₂), corresponds to the pH of the water that has been saturated. When receiving hydrogen water by direct electrolysis, the pH becomes slightly alkaline. The molecular hydrogen has extremely low water solubility. However, even under such conditions, its amount in water is sufficient for biochemical reactions. At normal atmospheric pressure, a maximum of 1.8 milliliters of hydrogen dissolves in approximately 1000 milliliters of water. This corresponds to approximately 1.8 parts per million.

In many scientific studies, molecular hydrogen exhibits anti-oxidant-like effects and properties. As of today, only three ways of antioxidant effect of molecular hydrogen have been studied. First, there is the inhibition of reactive oxygen species increase (free radicals). Hydrogen is able to inhibit and suppress the hydroxyl radical (OH) in human cells. Several pathways of molecular hydrogen exposure in the human body are already known with certainty. Secondly, the inhibition of reactive nitrogen species increased. The molecular hydrogen inhibits the formation of NO₂ which, in turn, suppresses the formation of ONOO— (peroxynitrite), which reduces oxidative stress. Thirdly, hydrogen water increases the regulation of powerful endogenous antioxidants. Human cells have their own natural defense system and produce the human body's own antioxidants, such as superoxide dismutase, catalase, and glutathione peroxidase. Hydrogen enhances the endogenous antioxidants by activating the Nrf2 keap1 system through the properties of hydrogen signal modulations.

Hydrogen water also has an anti-inflammatory effect. Hydrogen has a profound effect on the immune system and inflammatory process in the human body. This is accomplished by reducing oxidative stress, lowering inflammatory cytokine levels, and increasing the important anti-inflammatory cytokine level, in the prevention of inflammation. Hydrogen has a unique ability to penetrate cells and even tiny structures inside cells (organelles), such as mitochondria and the nucleus. No other molecules can penetrate deep into the cells. Hydrogen water achieves various paths. These include inflammatory cytokines reduction (TNF-alpha and gamma, IL-6, IL-1 beta, IL-10, IL-12, NF-kB), cancer-causing genes decrease (decrease in caspase 3, caspace 12, caspace 8, Bcl-2, BAX), increased activity of genes associated with cancer (bFGF, HGF, IFNy), reduced activity of genes associated with inflammation (i-NOS, VEGF, CCL2, ICAM1, PGE 2), energy metabolism increase (increased FGF21), increased ghretin, and detox genes activation (Nrf2 and heme-oxygenase-1).

A typical method of producing hydrogen-rich water occurs by adding electrolytes in water and dissolving the hydrogen gas in the water in order to produce the hydrogen-rich water. FIG. 1 illustrates such a system. Initially, water 10 is directed to a pretreatment 12. Water 10 can be in the nature of tapwater. The prefilter 12 can be in the nature of a screen, or other type of mechanical filter, that effectively separates large particulates from the remaining water. The pretreatment filter can also be an activated carbon filter. In FIG. 1, the prefiltered water passes from the pretreatment 12 as separate filtered waters streams 14 and 16 to an ionizer 20. When the pretreatment filter 12 is an activated carbon filter (used with a screen filter or a sediment filter), the pretreatment filter will filter in a bed of activated carbon. The activated carbon filter will remove impurities through adsorption. Activated carbon filter will remove some chlorine particles and some volatile organic compounds. The activated carbon filter would not effectively filter inorganics, fluorides or cyanide. This filtered water will pass through lines 14 and 16. As such, the filtrate from the pretreatment filter 12 will pass along lines 14 and 16 to the ionizer 20. Ionizer 20 is part of an electrolysis unit. The water is delivered to the ionizer. The ionizer will produce an output of hydrogen 22 and an output of an acidic water 24. The output will be approximately 50% hydrogenated water and 50% oxygenated water (or an acidic water).

The hydrogen in the water 22 that is produced will be very effective for use as a hydrogenated drinking water. The acidic water 24 would be simply discarded since it contains undesirable oxygen therein.

One of the problems associated with the prior art system shown in FIG. 1 is that a large number of suspended solids and impurities will pass from the pretreatment filter 12 into the ionizer 20. These dissolved solids can include minerals, salts, metals, cations or ions. They can also include inorganic salts, calcium, magnesium, potassium, sodium, bicarbonates, chlorides and sulfites. Ultimately, these total dissolved solids can flow to the ionizer 20. As such, it is desirable to remove such dissolved solids from the products produced from the ionizer 20.

Reverse osmosis filters have not been used, in the past, for the production of hydrogen water. The reason is that the reverse osmosis filter passes a very small percentage of the permeate from the original water. The remainder of the contaminant-containing water passes outwardly of the reverse osmosis filter as brine. If the completely filtered total dissolved solids-free water passes into the ionizer, then the ionizer becomes very ineffective at separating the hydrogen and oxygen components. The ions associated with the total dissolved solids are important in the electrolysizing of the water. As such, in the past, it was necessary to avoid the reverse osmosis filter since the ionizer would become relatively ineffective. It was necessary to avoid the reverse osmosis filter in order to enhance the performance of the ionizer. Additionally, in the prior art, there is a substantial amount of waste water since approximately 50% of the water from the ionizer must be removed since it contains the impurities and salts. In areas where water supply is scarce, this waste water would be unacceptable.

In the past, various patents and patent application publications have issued with respect to the hydrogenation of drinking water. For example, U.S. Pat. No. 8,974,646, issued on Mar. 10, 2015 to Park et al., describes a portable hydrogen-rich water generator. This hydrogen-rich water generator includes a separable drinking cup, an electrolytic cell which includes an anode, a cathode, and a solid polymer electrolyte membrane and is disposed at the bottom of the drinking cup. A reservoir base allows the drinking cup to be mounted thereto. An anode reaction of the electrolytic cell is generated in the reservoir base. A float valve allows the water to be continuously supplied of a certain water level from a water tank. A power supply applies direct current power to the electrolytic cell. When power is applied after putting purified water into the drinking cup and mounting the drinking cup on the reservoir base, the electrolytic cell electrolysizes the water in the reservoir base so that oxygen is generated at the anode of the reservoir base side and hydrogen is generated at the cathode of the drinking cup side. This allows hydrogen gas is to be dissolved in the purified water in the drinking cup within a short time. As such a hydrogen-rich water is produced.

U.S. Pat. No. 9,120,672, issued on Sep. 1, 2015 to Satoh et al., describes a hydrogen-containing fluid obtained through storing a hydrogen generating system which contains a hydrogen generating agent within a hydrogen bubble forming implement. The hydrogen bubble forming implement has a gas/liquid separating section including a gas-permeable film or an open-close type valve so as to cause the hydrogen generating system and a general purpose water to react in the hydrogen bubble forming implement. A hydrogen gas is generated in the hydrogen bubble forming implement.

U.S. Pat. No. 9,511,331, issued in Dec. 6, 2016 to J. Agarashi, discloses a process for continuously producing hydrogen-containing water for drinking. This process includes the steps (a) filtering and purifying water as a raw material; (b) degassing the purified water supplied to a degasser; (c) dissolving hydrogen gas in the degassed water supplied to a hydrogen dissolution device; (4) sterilizing the hydrogen-dissolved water supplied to a sterilizer, (e) filling the hydrogen-containing water supplied to a filling device in a sealed container and transferring the filled water product to a heat sterilizer; and (f) heat-sterilizing the water product supplied to the heat sterilizer. A portion of the hydrogen-containing water is returned to the degasser.

U.S. Pat. No. 10,421,673, issued on Sep. 24, 2019 to Luo et al., teaches a simple and efficient electrolysis device for making electrolyzer water from pure water. This device comprises a controllable electrolysis power supply, and an electrolytic electrode power plate. The component is immersed within the to-be-electrolyzer water when in operation. A gap is provided between an anode and a cathode of the electrolytic electrode plate assembly. This electrolysis device is used for making electrolysized water from pure water.

U.S. Patent Application Publication No. 2003/0132104, published on Jul. 17, 2003 to Yamashita et al., provides a hydrogen-dissolved water production apparatus. A degassing device, a hydrogen dissolving device, and a palladium catalyst column are provided in that order downstream of a high-purity water production device. An impurity removal device is connected to the exit side of treated water of the palladium catalyst column. The impurity removal device removes impurity ions which are eluted into the water to be treated for impurity particles which mix in with the water to be treated during the treatment in the palladium catalyst column. The impurity removal device comprises an ion exchange device and a membrane treatment device, such as in ultrafiltration membrane device, a reverse osmosis membrane device, or the like.

U.S. Patent Application Publication No. 2005/0224996, published on Oct. 13, 2005 to Y. Yoshida, shows a hydrogen-reduced water and method for preparing such hydrogen-reduced water. A pressure vessel is filled with hydrogen gas. The pressure of the hydrogen gas in the pressure vessel is maintained within a predetermined range. Raw water is introduced into the pressure vessel. The raw water is introduced into the pressure vessel as a shower from a nozzle provided at the upper interior of the pressure vessel. After contacting hydrogen gas with the raw water in the pressure vessel and dissolving the hydrogen gas in the raw water, the water is packaged and sealed in a highly airtight container.

U.S. Patent Application Publication No. 2016/0083856, published a Mar. 24, 2016 to Iwatsu et al., shows an electrolytic treatment using treatment subject ions contained in a treatment liquid. The method includes an ion positioning step for positioning a direct electrode and a counter electrode so as to sandwich the treatment liquid and positioning an indirect electrode for forming an electric field in the treatment liquid. A treatment subject ion migration step applies a voltage to the indirect electrode and thereby moves the treatment subject ions in the treatment liquid to the counter electrode side. A treatment subject ion redox step applies a voltage between the direct electrode and the counter electrode so as to oxidize or reduce the treatment subject ions that has migrated to the counter electrode side.

It is an object of the present invention to provide a process and system for producing hydrogenated drinking water which has a relatively small footprint.

It is another object of the present invention to provide a process and system for producing hydrogenated drinking water which assures that the hydrogenated drinking water is uncontaminated.

It is another object of the present invention to provide a process and system for producing hydrogenated drinking water that has mechanical and pneumatic barriers to contamination.

It is another object of the present invention to provide a process and system for producing hydrogenated drinking water that requires a minimal amount of electricity.

It is another object of the present invention provide a process and system for producing hydrogenated drinking water which requires less water consumption.

It is another object of the present invention to provide a process and system for producing hydrogenated drinking water which produces a pure hydrogenated water output.

It is another object of the present invention to provide a process and system for producing hydrogenated drinking water which quickly hydrogenates the water.

It is another object of the present invention to provide a process and system for producing hydrogenated drinking water which provides the ability to use reverse osmosis filtration and to achieve the benefits of reverse osmosis filtration.

It is another object of the present invention to provide a process and system for producing hydrogenated drinking water which guarantees that no contaminants remain in the hydrogenated water.

It is a further object of the present invention to provide a process and system for producing hydrogenated drinking water which improves the health and well-being of a person drinking the hydrogenated water.

It is still another object of the present invention to provide a process and system for producing a hydrogenated drinking water that utilizes salts and ions from the brine of a reverse osmosis filter to improve the operation of the ionizer.

It is a further object of the present invention to provide a process and system for producing a hydrogenated drinking water that maximizes the recovery of hydrogen in the hydrogenated water output.

These and other objects and advantages of the present invention will become apparent from a reading of the attached specification and appended claims.

### BRIEF SUMMARY OF THE INVENTION

The present invention is a process for producing ionized water. This process includes the steps of: (1) forming an ionization chamber having a cathode compartment and an anode compartment with a proton exchange membrane separating the cathode compartment from the anode compartment; (2) introducing a filtered water into the cathode compartment; (3) introducing a brine into the anode compartment; (4) applying an electrical charge to the anode compartment and the cathode compartment such that ions from the brine flow through the proton exchange membrane to the filtered water of the cathode compartment; and (5) removing the ionized filtered water from the cathode compartment.

In the present invention, the anode compartment and the cathode compartment have an osmotic pressure difference therebetween. This process further includes flowing a portion of the filtered water from the cathode compartment through the proton exchange membrane to the anode compartment. Hydrogen gas is produced from the portion of the filtered water in the anode compartment. The hydrogen gas then flows through the proton exchange membrane to the cathode compartment.

Tapwater is passed to the reverse osmosis filter so as to produce a permeate and the brine. The permeate is the filtered water that is introduced in the cathode compartment. Specifically, the permeate has a total dissolved solids of between one and ten parts per million. The brine has a total dissolved solids of greater than 100 parts per million.

Tapwater is passed through a pretreatment filter prior to the step of passing the tapwater through the reverse osmosis filter. This pretreatment filter can be an activated carbon filter or a sediment filter.

The step of applying a charge includes connecting a power supply to an electrode in the cathode compartment into another electrode in the anode compartment. Electrical energy of different polarities is delivered to the electrode in the anode compartment and to the electrode of the cathode compartment. The ions that flow from the anode compartment to the cathode compartment are hydrogen ions. The ionized filtered water is a hydrogenated water. Brine is then discharged from the anode compartment following the step of applying the charge. A mineral can be added to the permeate prior to passing from the reverse osmosis filter to the cathode compartment.

The present invention is also an apparatus for the ionization of water. This apparatus comprises an ionization chamber having a cathode compartment and an anode compartment with a proton exchange membrane therebetween. The cathode compartment is adapted to receive a filtered water therein. The anode compartment is adapted to receive a brine therein. Each of the cathode compartment and the anode compartment have an electrode therein. A power supply is connected to the electrodes of the cathode compartment and the anode compartment so as to apply an electrical charge thereto such that hydrogen ions from the brine in the anode compartment flow through the proton exchange membrane into the filtered water in the cathode compartment. An outlet is connected to the cathode compartment of the ionization chamber and adapted to allow ionized filtered water to be discharged from the cathode compartment. A reverse osmosis filter is in communication with the ionization chamber. The reverse osmosis filter is adapted to filter tapwater in order to form a permeate and the brine. The reverse osmosis filter has a first outlet connected to the cathode compartment so as to pass the filtered water into the cathode compartment. The reverse osmosis filter has a second outlet connected the anode compartment so as to pass the brine into the anode compartment.

The apparatus of the present invention further has a housing having an interior. The ionization chamber and the reverse osmosis filter are positioned in the interior of the housing. The housing has an outlet connected to or part of the outlet of the cathode compartment of the ionization chamber. A supply of minerals or supplements is connected or interconnected to the first outlet of the reverse osmosis filter so as to add the minerals or supplements to the filtered water from the reverse osmosis filter. The anode compartment of the ionization chamber has a discharge line connected thereto so as to discharge brine from the anode compartment.

The cathode compartment and the anode compartment have an osmotic pressure differential therebetween so as to cause the filtered water to pass from the cathode compartment to the proton exchange membrane into the anode compartment. The anode compartment produces hydrogen ions from the filtered water.

The power supply transmits an electrical charge of a positive polarity to the anode compartment and an electrical charge of a negative polarity to the cathode compartment. A pretreatment filter is positioned in the housing and connected to a source of tapwater so as to filter the tapwater prior to passing to the reverse osmosis filter. The pretreatment filter is, in one embodiment of the present invention, a sediment filter adapted to remove suspended solids from the tapwater. Alternatively, the pretreatment filter is an activated carbon filter adapted to remove contaminants from the tapwater. The pretreatment filter could also be the combination of a sediment filter and an activated carbon filter.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE DRAWINGS

FIG. 1 is a block diagram showing the operation of a prior art system for producing hydrogenated water.

FIG. 2 is a block diagram showing a simplified version of the process and system of the present invention for producing a hydrogenated drinking water output.

FIG. 3 is a further block diagram showing another simplified version of the process and system of the present invention for producing a hydrogenated drinking water output which includes mineral dosing.

FIG. 4 is a cross-sectional view showing the ionization chamber of the present invention.

FIG. 5 is an upper perspective view showing the apparatus of the present invention employing the ionization chamber of the present invention.

FIG. 6 is an upper perspective view of the interior components of the apparatus of the present invention which employs the ionization chamber.

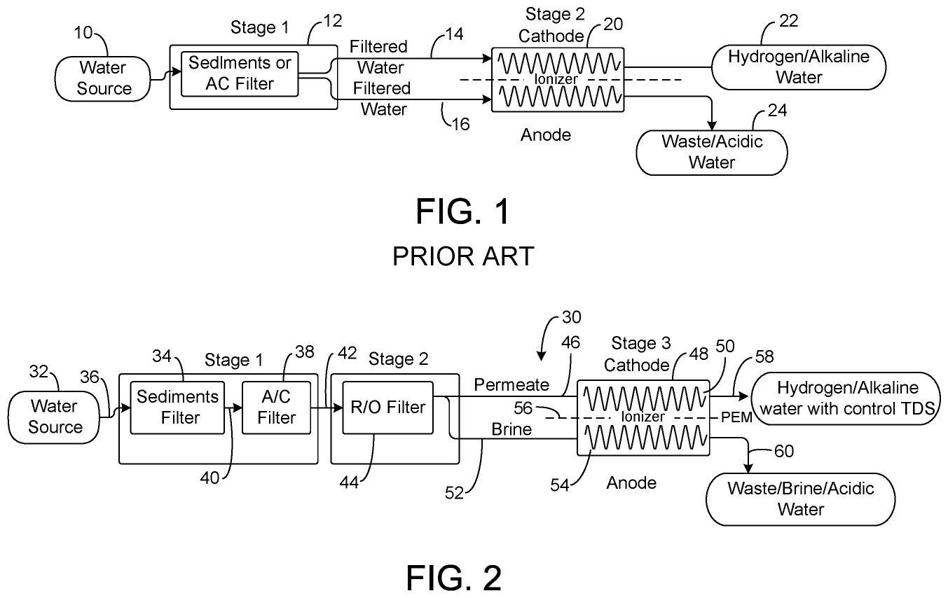

### DETAILED DESCRIPTION OF THE INVENTION

Referring to FIG. 2, there is shown the system 30 for the production of a hydrogenated water in accordance with a preferred embodiment of the present invention. System 30 includes a water supply 32. Water supply 32 can be in the nature of a tapwater supply. A pretreatment filter 34 is connected to the water supply 32 by a line 36. Pretreatment filter 34 can be in the nature of an activated carbon filter, a screen filter, a sand filter, or other device wherein particulate impurities in the water supplied from the water supply 32 are separated from the flow passing from the pretreatment filter 34 into an activated carbon filter 38. In particular, the pretreatment filter 34, as shown in FIG. 2 is a sediment filter.

The water will pass from the sediment filter 34 through line 40 to the activated carbon filter 38. The activated carbon filter 38 has a bed of activated carbon. This activated carbon filter 38 serves to remove impurities through adsorption. The remove some chlorines, particulates such as sediment, and volatile organic compounds. It does not effectively filter inorganics, fluoride, or cyanide. The water passing through line 42 to the reverse osmosis filter 44 will contain a certain amount of total dissolved solids. These total dissolved solids can include minerals, salts, metals, cations or anions. It can also include inorganic salts, calcium, magnesium, potassium, sodium, bicarbonates, chlorides and sulfites. Typically, a pump will be provided along line 42 or in cooperation with line 42 so as to apply a pressure approximately 80 p.s.i. to the flow to the reverse osmosis filter 44.

The reverse osmosis filter 44 completely filters the impurities from the water. In particular, the reverse osmosis filter 44 will remove inorganics and fluorides. Generally, only the pure water molecules will get through and pass as permeate 46. This permeate 46 will have total dissolved solids of less than ten parts per million. The permeate 46 passes to the ionizer 48. Since the permeate 46 is pure water, it is too clean for the ionizer 48. There are no ions, minerals or salts for properly charging by the ionizer 48. The absence or small amount of such total dissolved solids from the permeate 46 will significantly reduce conductivity within the ionizer 48.

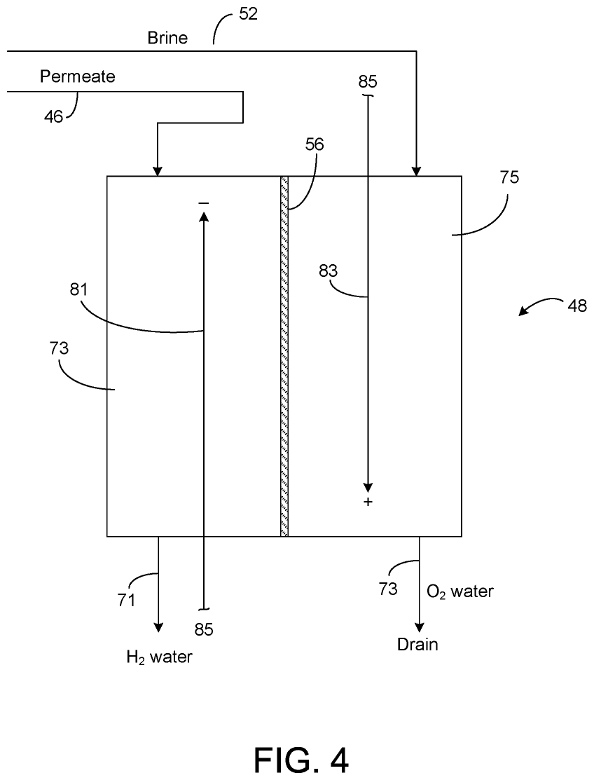

The permeate 46 passes outwardly of the reverse osmosis filter through the permeate line 46 into a cathode compartment 50 of the ionizer 48. The reverse osmosis filter 44 has another line 52 that serves to deliver the brine from the reverse osmosis 44 into a brine compartment 54 of the ionizer chamber 48. A proton exchange membrane 56 separates the cathode compartment 50 from the anode compartment 54. The brine 52 that passes into the anode compartment 54 will have a total dissolved solids content of greater than 100 parts per million. The ionizer 48 is shown in greater detail in association with FIG. 4.

Importantly, the permeate 46 is essentially pure water containing no contaminants, salts or other dissolved solids. As such, it will contain virtually no ions with which to electrolyze the solution within the cathode compartment 50 of the ionizer 48. Any attempt to electrolyze such ions within the ionizer 48 would be extremely ineffective in achieving a proper hydrogenated drinking water output. As such, in order to allow the electrolysis process to be conducted properly within ionizer 48, it is necessary to introduce the salts and ions into the ionizer 48. In the present invention, this is achieved by introducing at least a portion of the brine 52 from the reverse osmosis filter 44.

The membrane 56 is positioned between the cathode compartment 50 and the anode compartment 54. The membrane 56 is a proton exchange membrane, such as that manufactured by DuPont under the trademark “MAFFION”™. The proton exchange membrane 56 assures that only hydrogen molecules migrate through the membrane 56 from the anode compartment 58 into the cathode compartment 50 during the electrolysis process. As such, membrane 56 provides a “mechanical” barrier against the migration of oxygen and other contaminants from the anode compartment 54 into the cathode compartment 50.

Additionally and furthermore, the permeate 46 will flow into the cathode compartment 50 under a significant amount of pressure. In contrast, the brine 52 will flow into the anode compartment 54 under much less pressure. Since the fluid pressure within the cathode compartment 50 is greater than the fluid pressure within the anode compartment 54, this pressure differential will resist any flow from the anode compartment 54 into the cathode compartment 50. Once again, this assures that contamination of the water within the cathode compartment 50 is avoided since this presents a pneumatic barrier to the fluid flow from the anode compartment 54 to the cathode compartment 50. As such, the present invention absolutely assures that the hydrogenated drinking water from the cathode compartment is free of contamination.

It is important to realize that the protons that travel from the cathode compartment 50 to the anode compartment 54 in the ionizer 48 are carried by the flow of water. The water is driven to the anode compartment 54 by the osmotic pressure difference between the cathode compartment 50 and the anode compartment 54 of the ionizer 48. The osmotic pressure difference is caused by the fact that the total dissolved solids of the brine water in the anode compartment 54 is higher than the total dissolved solids of reverse osmosis filtered water in the cathode compartment 50. The high total dissolved solids of the brine water means that there are more dissolved ions in the brine water than in the reverse osmosis water. The dissolved ions in the brine water attract water molecules. This attraction is what drives the flow of water from the cathode compartment 50 to the anode compartment 54. The protons are carried along with this flow of water. Once protons reach the anode compartment 54, they are used to produce hydrogen gas. The hydrogen gas then travels through the proton exchange membrane 56 to the cathode compartment 50. The hydrogen gas is then collected in this cathode compartment 50. Therefore, even though protons have an affinity for the cathode compartment 50, they can still travel from the cathode compartment 50 to the anode compartment 54 in the ionizer 48 due to the osmotic pressure difference and the semipermeable nature of the proton exchange membrane 56.

The ionizer 48 includes a first outlet 58 and a second outlet 60. The first outlet 58 passes the hydrogenated drinking water from the cathode compartment 50. The second outlet 60 passes the oxygenated water (along with the contaminants) outwardly of the anode compartment 54. The oxygenated water and the contaminants can be disposed in any desired manner.

The process and system of the present invention, as shown in FIG. 2, achieve significant advantages over the prior art. First, the present invention allows the use of reverse osmosis for the filtering of the tapwater 32. As such, the reverse osmosis filter 44 effectively removes all of the contaminants and the total dissolved solids from the tapwater. This extremely pure water will pass as pure permeate 46 to the cathode compartment 50 of the ionizer 48. As such, it is assured that very pure water will reside in the cathode compartment 50.

It is important for the present invention to avoid the waste of water and avoid the addition of expensive minerals and other substances for the purposes of enhancing the electrolytic reaction within the ionizer 48. As such, the present invention passes the highly salted and contaminated brine 52 from the reverse osmosis filter 44 into the anode compartment 54 of the ionizer 48. The proton exchange membrane 56 assures that the highly salted and contaminated brine 42 will not migrate into the pure water within the cathode compartment 50. Additionally, the pressure differential between the pure water in the cathode compartment 50 and the contaminated water in the anode compartment 54 will assure (by hydraulic means) that there is no flow of contaminated water from the anode compartment 54 into the cathode compartment 50. Since the brine from the reverse osmosis process is introduced into the ionizer 48, there is no need to add minerals so as to effect the electrolysis process. The minerals are contained in the tapwater that is originally filtered by the reverse osmosis filter 44. Additionally, since the brine 52 is highly salted, this will assure that the electrolysis process is carried out very quickly and with a minimal amount of electricity. Ultimately, after the electrolysis process is carried out, highly contaminated and highly salted oxygenated water can be properly disposed. Unlike the prior art, approximately 75% of the water is preserved in the process of the present invention in comparison with 50% of the water in the prior art. Since the brine is highly concentrated with salts, the footprint of the ionizer 48 can be very small for the carrying out of the hydrogenation of the drinking water.

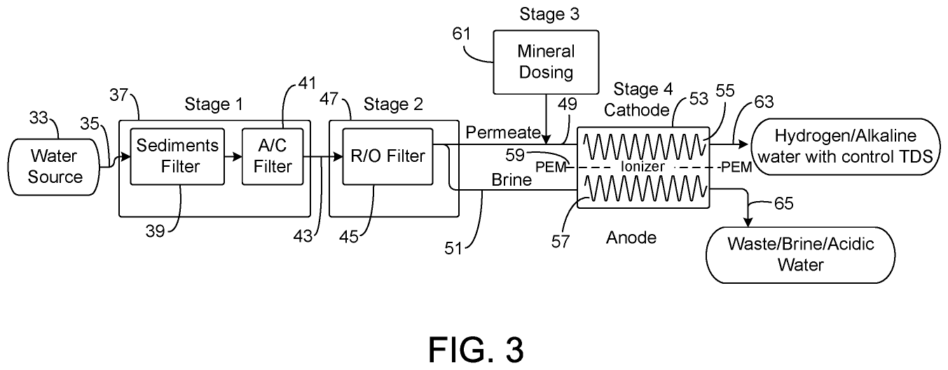

FIG. 3 shows a slightly modified embodiment of the present invention. In particular, in FIG. 3, it can be seen that there is a water source 33 that has a line 35 connected to a first stage 37. The first stage 37 includes a sediments filter 39 and an activated carbon filter 41. As such, the tapwater from the water source 33 can flow through the sediments filter 39 and then through the activated carbon filter 41. Ultimately, this pre-filtered water will flow through line 43 into a reverse osmosis filter 45 in a second stage 47. The reverse osmosis filter 45 will then separate the prefiltered water into a permeate flow 49 and a brine flow 51. These will flow into the ionizer 53. In particular, the permeate (pure water) will flow into the cathode compartment 55. The brine will flow into the anode compartment 57. A proton exchange membrane 59 will separate the cathode compartment 55 from the anode compartment 57.

An important difference shown in FIG. 3 is that there is a mineral doser 61 that is connected to the permeate line 49. As such, so as to enhance the electrolytic process and to enhance the taste characteristics of the hydrogenated water, minerals or supplements can be added from the doser 61 into the permeate 49 flowing to the cathode compartment 55. These minerals can also enhance the electrolytic process of the ionizer 53.

The protons that travel in water from the cathode compartment 55 to the anode compartment 57 can act as a catalyst for the anode compartment 57 to produce more hydrogen. This is because the protons can help to disassociate water molecules at the anode compartment 57, which produces more protons and electrons. The electrons can then travel through the external circuit to the cathode compartment 55, where they combined with protons to produce hydrogen gas.

The protons that travel in water from the cathode compartment 55 to the anode compartment 57 can help to improve the mass transfer of protons from the bulk electrolyte to the surface of the anode catalyst. This is important because a hydrogen evolution reaction occurs at the surface of the anode catalyst. By improving mass transfer, the protons that travel in water from the cathode compartment 55 to the anode compartment 57 can help to ensure that there is always a sufficient supply of protons available at the catalyst surface for the hydrogen evolution reaction to proceed at a high rate. Therefore, the protons that travel in water from the cathode compartment 55 to the anode compartment 57 can act as a catalyst for the anode compartment 57 to produce more hydrogen in two ways. First, this is accomplished by helping to disassociate water molecules at the anode compartment 57 so as to produce more protons and electrons. Secondly, this occurs by improving the mass transfer of protons from the bulk electrolyte to the surface of the anode catalyst.

It is important to note that the protons are traveling from the cathode compartment 55 to the anode compartment 57 can also damage the proton exchange membrane 57 over time. Therefore, it is important to carefully design and operate the process in order to optimize the flow of water and maximize hydrogen production while minimizing the risk of damage to the proton exchange membrane 59.

The hydrogenated water (along with mineral dosing) can the removed from the cathode compartment 55 through the outlet line 63. The waste/brine/acidic water can be removed from the anode compartment 57 along line 65.

FIG. 4 shows that there is a first conductor 81 positioned in the cathode compartment 73 and a second conductor 83 positioned in the anode compartment 75. The first conductor 81 will pass a negative charge from power supply 85 into the cathode compartment 73. The second conductor 83 will pass a positive charge from power supply 85 into the anode compartment 75. The charging of the first conductor 81 and the second conductor 83 will charge the salts within the brine 52 within the anode compartment 75 so as to cause the hydrogen molecules to migrate toward and through the proton exchange membrane 56 into the cathode compartment 73. Ultimately, in order to create the necessary electrical conductivity between the fluids in the cathode compartment 73 and the anode compartment 75, the surfaces of the proton exchange membrane 56 will need to be soaked with the respective fluids. Only hydrogen molecules can migrate from the highly salted and contaminated water within the anode compartment 75 to the cathode compartment 73. As such, only hydrogen molecules will bubble through the proton exchange membrane 56 and dissolve in the water in the cathode compartment 73. Ultimately, this hydrogenated drinking water can be discharged through the outlet 71 for consumption by a user. The residual oxygenated water will pass through the outlet 73 for disposal.

The protons that travel from the cathode compartment 73 to the anode compartment 75 in the ionizer 48 are carried by the flow of water. The water is driven to the anode compartment 75 by the osmotic pressure difference between the cathode and anode sides of the proton exchange membrane 56. The osmotic pressure difference is caused by the fact that the total dissolved solids of the brine water in the anode compartment 75 is higher than the total dissolved solids of the reverse osmosis water in the cathode compartment 73. The high total dissolved solids of the brine water means that there are more dissolved ions in the brine water than in the reverse osmosis water. The dissolved ions in the brine water attract water molecules. This attraction is what drives the flow of water from the cathode compartment 73 to the anode compartment 75. The protons are carried along with the flow of water. Once the protons reach the anode compartment 75, they are used to produce hydrogen gas. Hydrogen gas then travels to the proton exchange membrane 56 to the cathode compartment 73, where it is collected. Therefore, even though protons have an affinity for the cathode compartment 73, they can still travel from the cathode compartment 73 to the anode compartment 75 in the ionizer 48 due to the osmotic pressure difference and semi-permeable nature of the proton exchange membrane 56.

There are also some additional factors that affect the flow of protons from the cathode compartment 73 to the anode compartment 75 in the ionizer 48. These factors include the temperature of the electrolyte, the pressure difference between the cathode compartment 73 and the anode compartment 75 of the ionizer 48, and the type of proton exchange membrane material used.

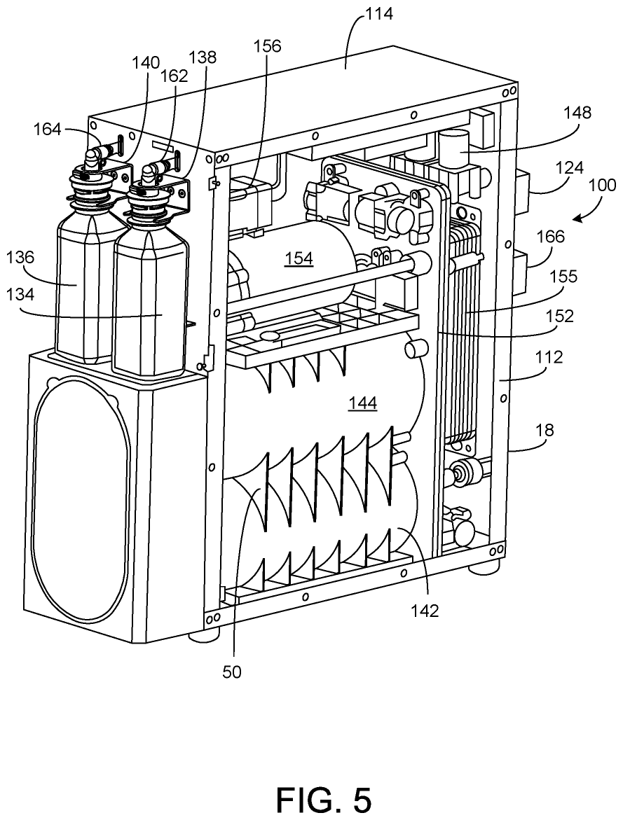

FIG. 5 shows the interior of the water mineralization system 100 of the present invention. In particular, FIG. 5 shows the first filter 142 and the second filter 144 arranged one on top of another adjacent to the bottom of the housing 112. Bottles 134 and 136 are positioned adjacent to the top of the housing 112. A peristaltic pump 156 is positioned adjacent to a container receptacle assembly 138. Peristaltic pump 156 is positioned adjacent to the container receptacle assembly 140. A line or conduit will extend from the elbows 162 and 164 of the respective container receptacle assemblies 138 and 140 to the respective peristaltic pumps 156.

FIG. 5 shows the configuration of the inlet 124 and the outlet 166. Inlet 124 receives the tapwater into the interior of the housing 112. Outlet 166 allows for the discharge of mineralized drinking water from the housing 112. Valve 148 extends outwardly from the inlet 124 and operates to control the flow of water through the inlet 124. Another valve associated with the outlet 166 can control the flow of mineralized and hydrogenated drinking water out of the outlet 166. Initially, the tapwater will flow through the inlet 124 and down to the first filter 142 for pretreatment purposes. The outlet of the first filter 142 will flow to the diaphragm pump 154 for pressurization prior to passing to the reverse osmosis filter 144. Ultimately, the filtered water from the reverse osmosis filter 144 will be devoid of minerals. It can then flow into the manifold 152 for mixing with a mineral-containing liquid from the bottles 134 and 136. After mixing, the manifold 152 will then pass the flow of mineralized drinking water to the ionizer 155. Ionizer 155 will have the configuration similar to that shown in the previous embodiments of the present invention.

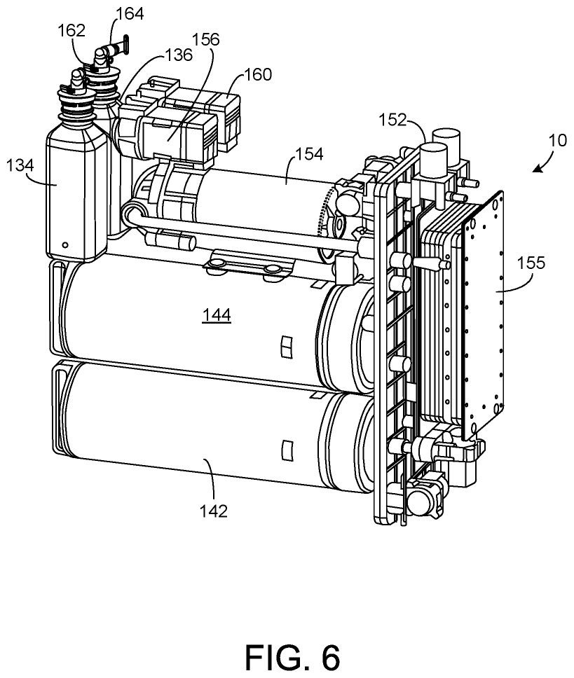

FIG. 6 shows the interior components isolated from the housing 112 of FIG. 5. In particular, FIG. 6 shows the pretreatment filter 142 and the reverse osmosis filter 144 arranged in a stacked configuration. A diaphragm pump 154 serves to pump the pretreated water from the pretreatment filter 142 through the reverse osmosis filter 144 and into the manifold 152. Ultimately, the manifold 152 can direct the filtered water (as mixed with a mineral or supplement) into the ionizer 155.

The mineral or supplement can be provided by bottles 134. Bottles 134 will be connected to the peristaltic pumps 156 and 160 by way of respective elbows 162 and 164. As such, the peristaltic pumps 156 and 160 can draw a desired amount of mineral or supplement from the respective bottles 134 and 136 and ultimately pass this mineral or supplement to the manifold 152 for mixing prior to ionizing in the ionization chamber 155.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents

I claim:

1. A process for ionizing water, the process comprising:
forming an ionization chamber having a cathode compartment and an anode compartment with a proton exchange membrane separating the cathode compartment from the anode compartment;
introducing a filtered water into the cathode compartment;
introducing a brine into the anode compartment;
applying an electrical charge to the anode compartment and to the cathode compartment such that ions from the brine in the anode compartment flow through the proton exchange membrane to the filtered water in the cathode compartment; and
removing the ionized filtered water from the cathode compartment.

2. The process of claim 1, wherein the anode compartment and the cathode compartment has an osmotic pressure difference therebetween, the process further comprising:
flowing a portion of the filtered water from the cathode compartment through the proton exchange membrane into the anode compartment;
producing hydrogen gas from the portion of the filtered water in the anode compartment; and
flowing the hydrogen gas through the proton exchange membrane to the cathode compartment.

3. The process of claim 1, further comprising:
passing tapwater through the through a reverse osmosis filter so as to produce a permeate and the brine, the permeate being the filtered water introduced into the cathode compartment.

4. The process of claim 3, wherein the permeate has a total dissolved solids of one to ten parts per million, the brine having a total dissolved solids of greater than 100 parts per million.

5. The process of claim 3, further comprising:
passing the tapwater through a pretreatment filter prior to the step of passing the tapwater through the reverse osmosis filter.

6. The process of claim 5, the pretreatment filter being an activated carbon filter or a sediment filter.

7. The process of claim 1, the step of applying the charge comprising:
connecting a power supply to an electrode in the cathode compartment and to another electrode in the anode compartment; and
delivering an electrical energy of different polarities to the electrode of the anode compartment and to the another electrode of the cathode compartment.

8. The process of claim 1, wherein the ions flowing from the anode compartment to the cathode compartment are hydrogen ions.

9. The process claim 8, wherein the ionized filtered water is hydrogenated water.

10. The process of claim 1, further comprising:
discharging the brine from the anode compartment following the step of applying a charge.

11. The process of claim 3, further comprising:
adding a mineral to the permeate passing from the reverse osmosis filter to the cathode compartment.

12. An apparatus for the ionization of water, the apparatus comprising:
an ionization chamber having a cathode compartment and an anode compartment with a proton exchange membrane therebetween, the cathode compartment adapted to receive a filtered water therein, the anode compartment adapted to receive a brine therein, each of the cathode compartment and the anode compartment having an electrode therein;
a power supply connected to the electrodes of the cathode compartment and the anode compartment so as to apply an electrical charge thereto such that the hydrogen ions from the brine in the anode compartment flow through the proton exchange membrane into the filtered water in the cathode compartment;
an outlet connected to the cathode compartment of said ionization chamber and adapted to allow ionized filtered water to be discharged from the cathode compartment; and
a reverse osmosis filter in communication with said ionization chamber, said reverse osmosis filter adapted to filter tapwater in order to form a permeate and the brine, the reverse osmosis filter having a first outlet connected to the cathode compartment so as to pass the filtered water into the cathode compartment, said reverse osmosis filter having a second outlet connected to the anode compartment so as to pass the brine into the anode compartment.

13. The apparatus of claim 12, further comprising:
a housing having an interior, wherein said ionization chamber and said reverse osmosis filter are positioned in the interior of said housing, said housing having an outlet connected to or part of said outlet of said cathode compartment of said ionization chamber.

14. The apparatus of claim 12, further comprising:
a supply of a mineral or supplement connected or interconnected to the first outlet of said reverse osmosis filter and adapted to add the mineral or supplement to the filtered water from said reverse osmosis filter.

15. The apparatus of claim 12, wherein the anode compartment of said ionization chamber has a discharge line connected thereto so as to discharge brine from the anode compartment.

16. The apparatus of claim 12, wherein the cathode compartment and the anode compartment have an osmotic pressure differential therebetween so as to cause the filtered water to pass from the cathode compartment to the proton exchange membrane into the anode compartment, the anode compartment producing hydrogen ions from the filtered water.

17. The apparatus of claim 12, wherein said power supply transmits an electrical charge of a positive polarity to the anode compartment and electrical charge of a negative polarity to the cathode compartment.

18. The apparatus of claim 13, further comprising:
a pretreatment filter positioned in said housing and connected to a source of tapwater so as to filter the tapwater prior to passing to the reverse osmosis filter.

19. The apparatus of claim 18, the pretreatment filter being a sediment filter adapted to remove suspended solids from the tapwater.

20. The apparatus of claim 18, the pretreatment filter being an activated carbon filter adapted to remove contaminants from the tapwater.
